(19) United States
(12) Patent Application Publication
(10) Pub. No.: US 2018/0014216 A1
(43) Pub. Date: Jan. 11, 2018

(54) LOW POWER AND LONG RANGE PREAMBLES FOR A WIRELESS LOCAL AREA NETWORK

(71) Applicant: QUALCOMM Incorporated, San Diego, CA (US)

(72) Inventors: Raja BANERJEA, San Jose, CA (US); Bin TIAN, San Diego, CA (US); Sameer VERMANI, San Diego, CA (US)

(21) Appl. No.: 15/645,727

(22) Filed: Jul. 10, 2017

Related U.S. Application Data
(60) Provisional application No. 62/360,577, filed on Jul. 11, 2016.

(51) Int. Cl. H04W 24/08; H04W 56/00; H04W 84/12

(52) U.S. Cl. CPC H04W 24/08; H04W 56/0035; H04W 84/12

(57) ABSTRACT

A method, an apparatus, and a computer-readable medium for wireless communication are provided. In certain aspects, the apparatus may be configured to receive a signal that comprises a first training field and an identifier associated with a wireless device in a preamble of the signal. In certain other aspects, the apparatus may be configured to estimate one or more of a frequency offset of the signal or a timing offset of the signal based at least in part on the first training field and the identifier associated with the wireless device. In certain other aspect, the apparatus may be configured to perform packet detection based at least in part on the first training field and the identifier associated with the wireless device.

### CROSS-REFERENCE TO RELATED APPLICATION(S)

This application claims the benefit of U.S. Provisional Application Ser. No. 62/360,577, entitled “LOW POWER AND LONG RANGE PREAMBLES FOR WLAN” and filed on Jul. 11, 2016, which is expressly incorporated by reference herein in its entirety.

### BACKGROUND

### Field

The present disclosure relates generally to communication systems, and more particularly, to enabling low power and long range preambles for wireless local area networks.

### Background

In many telecommunication systems, communications networks are used to exchange messages among several interacting spatially-separated devices. Networks may be classified according to geographic scope, which could be, for example, a metropolitan area, a local area, or a personal area. Such networks would be designated respectively as a wide area network (WAN), metropolitan area network (MAN), local area network (LAN), wireless local area network (WLAN), or personal area network (PAN). Networks also differ according to the switching/routing technique used to interconnect the various network nodes and devices (e.g., circuit switching vs. packet switching), the type of physical media employed for transmission (e.g., wired vs. wireless), and the set of communication protocols used (e.g., Internet protocol suite, Synchronous Optical Networking (SONET), Ethernet, etc.).

Wireless networks are often preferred when the network elements are mobile and thus have dynamic connectivity needs, or if the network architecture is formed in an ad hoc, rather than fixed, topology. Wireless networks employ intangible physical media in an unguided propagation mode using electromagnetic waves in the radio, microwave, infra-red, optical, etc., frequency bands. Wireless networks advantageously facilitate user mobility and rapid field deployment when compared to fixed wired networks.

### SUMMARY

The systems, methods, computer-readable media, and devices of aspects of the invention each have several aspects, no single one of which is solely responsible for the invention's desirable attributes. Without limiting the scope of various aspects of the invention as expressed by the claims which follow, some features will now be discussed briefly. After considering this discussion, and particularly after reading the section entitled “Detailed Description,” one will understand how the features of aspects of the invention provide advantages for devices in a wireless network.

One aspect of this disclosure provides an apparatus (e.g., a station or an access point) for wireless communication. The apparatus may be configured to receive a signal that comprises a first training field and an identifier associated with a wireless device in a preamble of the signal. The apparatus may be configured to estimate one or more of a frequency offset of the signal or a timing offset of the signal based at least in part on the first training field and the identifier associated with the wireless device. The apparatus may be configured to perform packet detection based at least in part on the first training field and the identifier associated with the wireless device.

### BRIEF DESCRIPTION OF THE DRAWINGS

FIG. 1 shows an example wireless communication system in which aspects of the present disclosure may be employed.

FIG. 2 is a diagram of a wireless network (e.g., a Wi-Fi network).

FIG. 3 illustrates an OFDM training structure.

FIG. 4 is a diagram illustrating a first method of packet detection using a short training field (STF) and a long training field (LTF).

FIG. 5 is a diagram illustrating a second method of packet detection using STF, LTF, and an identifier

FIG. 6 is a diagram illustrating a third method of packet detection in the frequency domain.

FIGS. 7A and 7B illustrate a first frame structure and a second frame structure with shortened effective preamble durations.

FIG. 8 is a functional block diagram of a wireless device that may be employed within the wireless communication system of FIG. 1 for performing packet detection.

FIGS. 9A and 9B are a flowchart of an exemplary method of wireless communication for packet detection.

FIG. 10 is a functional block diagram of an exemplary wireless communication device for performing packet detection.

### DETAILED DESCRIPTION

Various aspects of the systems, apparatuses, computer program products, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the systems, apparatuses, computer program products, and methods disclosed herein, whether implemented independently of, or combined with, any other aspect of the invention. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the invention set forth herein. It should be understood that any aspect disclosed herein may be embodied by one or more elements of a claim.

Although particular aspects are described herein, many variations and permutations of such aspects fall within the scope of the disclosure. Although some benefits and advantages of particular aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the aspects. The detailed description and drawings are merely illustrative of the disclosure rather than limiting, the scope of the disclosure being defined by the appended claims and equivalents thereof

Popular wireless network technologies may include various types of WLANs. A WLAN may be used to interconnect nearby devices together, employing widely used networking protocols. The various aspects described herein may apply to any communication standard, such as a wireless protocol.

In some aspects, wireless signals may be transmitted according to an 802.11 protocol using orthogonal frequency-division multiplexing (OFDM), direct-sequence spread spectrum (DSSS) communications, a combination of OFDM and DSSS communications, or other schemes. Implementations of the 802.11 protocol may be used for sensors, metering, and smart grid networks. Advantageously, aspects of certain devices implementing the 802.11 protocol may consume less power than devices implementing other wireless protocols, and/or may be used to transmit wireless signals across a relatively long range, for example about one kilometer or longer.

In some implementations, a WLAN includes various devices which are the components that access the wireless network. For example, there may be two types of devices: access points (APs) and clients (also referred to as stations or “STAs”). In general, an AP may serve as a hub or base station for the WLAN and a STA serves as a user of the WLAN. For example, a STA may be a laptop computer, a personal digital assistant (PDA), a mobile phone, etc. In an example, a STA connects to an AP via a Wi-Fi (e.g., IEEE 802.11 protocol) compliant wireless link to obtain general connectivity to the Internet or to other wide area networks. In some implementations a STA may also be used as an AP.

An access point may also comprise, be implemented as, or known as a NodeB, Radio Network Controller (RNC), evolved NodeB (eNodeB), Base Station Controller (BSC), Base Transceiver Station (BTS), Base Station (BS), Transceiver Function (TF), Radio Router, Radio Transceiver, connection point, or some other terminology.

A station may also comprise, be implemented as, or known as an access terminal (AT), a subscriber station, a subscriber unit, a mobile station, a remote station, a remote terminal, a user terminal, a user agent, a user device, a user equipment, or some other terminology. In some implementations, a station may comprise a cellular telephone, a cordless telephone, a Session Initiation Protocol (SIP) phone, a wireless local loop (WLL) station, a personal digital assistant (PDA), a handheld device having wireless connection capability, or some other suitable processing device coupled to a wireless modem. Accordingly, one or more aspects taught herein may be incorporated into a phone (e.g., a cellular phone or smartphone), a computer (e.g., a laptop), a portable communication device, a headset, a portable computing device (e.g., a personal data assistant), an entertainment device (e.g., a music or video device, or a satellite radio), a gaming device or system, a global positioning system device, or any other suitable device that is configured to communicate via a wireless medium.

In an aspect, MIMO schemes may be used for wide area WLAN (e.g., Wi-Fi) connectivity. MIMO exploits a radio-wave characteristic called multipath. In multipath, transmitted data may bounce off objects (e.g., walls, doors, furniture), reaching the receiving antenna multiple times through different routes and at different times. A WLAN device that employs MIMO will split a data stream into multiple parts, called spatial streams (or multi-streams), and transmit each spatial stream through separate antennas to corresponding antennas on a receiving WLAN device.

The term “associate,” or “association,” or any variant thereof should be given the broadest meaning possible within the context of the present disclosure. By way of example, when a first apparatus associates with a second apparatus, it should be understood that the two apparatuses may be directly associated or intermediate apparatuses may be present. For purposes of brevity, the process for establishing an association between two apparatuses will be described using a handshake protocol that requires an “association request” by one of the apparatus followed by an “association response” by the other apparatus. It will be understood by those skilled in the art that the handshake protocol may require other signaling, such as by way of example, signaling to provide authentication.

Any reference to an element herein using a designation such as “first,” “second,” and so forth does not generally limit the quantity or order of those elements. Rather, these designations are used herein as a convenient method of distinguishing between two or more elements or instances of an element. Thus, a reference to first and second elements does not mean that only two elements can be employed, or that the first element must precede the second element. In addition, a phrase referring to “at least one of” a list of items refers to any combination of those items, including single members. As an example, “at least one of: A, B, or C” is intended to cover: A, or B, or C, or any combination thereof (e.g., A-B, A-C, B-C, and A-B-C).

As discussed above, certain devices described herein may implement the 802.11 standard, for example. Such devices, whether used as a STA or AP or other device, may be used for smart metering or in a smart grid network. Such devices may provide sensor applications or be used in home automation. The devices may instead or in addition be used in a healthcare context, for example for personal healthcare. The devices may also be used for surveillance, to enable extended-range Internet connectivity (e.g. for use with hotspots), or to implement machine-to-machine communications.

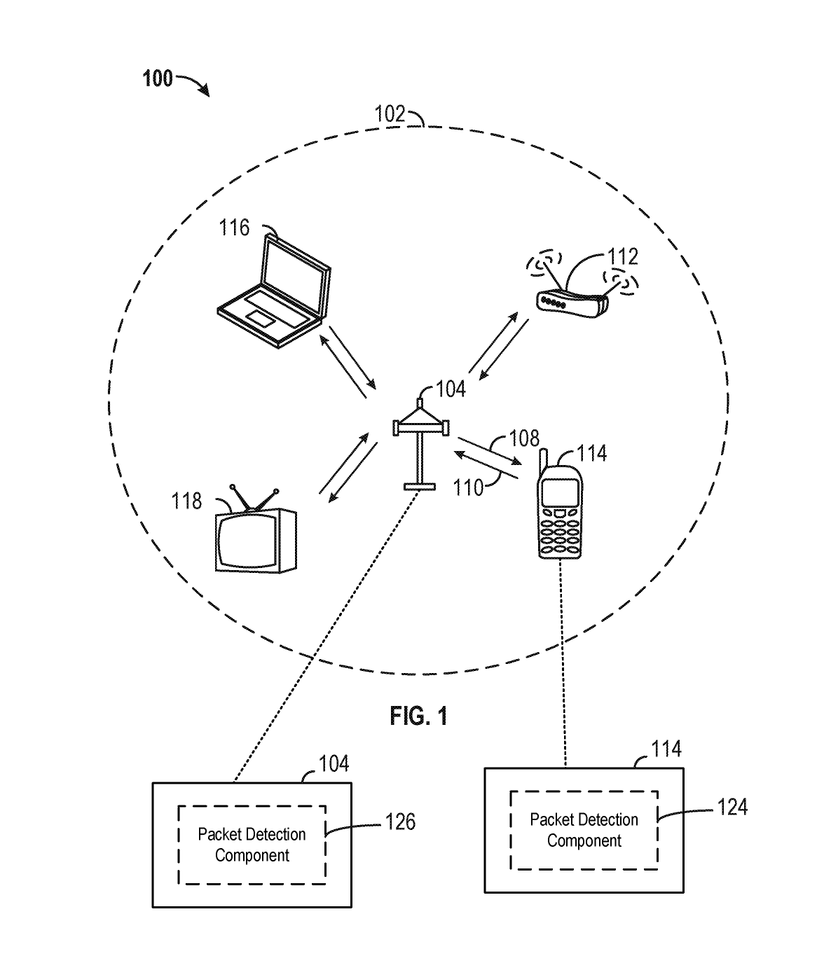

FIG. 1 shows an example wireless communication system 100 in which aspects of the present disclosure may be employed. The wireless communication system 100 may operate pursuant to a wireless standard, for example the IEEE 802.11 standard. The wireless communication system 100 may include an AP 104, which communicates with STAs (e.g., STAs 112, 114, 116, and 118).

A variety of processes and methods may be used for transmissions in the wireless communication system 100 between the AP 104 and the STAs. For example, signals may be sent and received between the AP 104 and the STAs in accordance with OFDM/OFDMA techniques. If this is the case, the wireless communication system 100 may be referred to as an OFDM/OFDMA system. Alternatively, signals may be sent and received between the AP 104 and the STAs in accordance with CDMA techniques. If this is the case, the wireless communication system 100 may be referred to as a CDMA system.

A communication link that facilitates transmission from the AP 104 to one or more of the STAs may be referred to as a downlink (DL) 108, and a communication link that facilitates transmission from one or more of the STAs to the AP 104 may be referred to as an uplink (UL) 110. Alternatively, a downlink 108 may be referred to as a forward link or a forward channel, and an uplink 110 may be referred to as a reverse link or a reverse channel. In some aspects, DL communications may include unicast or multicast traffic indications.

The AP 104 may suppress adjacent channel interference (ACI) in some aspects so that the AP 104 may receive UL communications on more than one channel simultaneously without causing significant analog-to-digital conversion (ADC) clipping noise. The AP 104 may increase suppression of ACI, for example, by having separate finite impulse response (FIR) filters for each channel or having a longer ADC backoff period with increased bit widths.

The AP 104 may act as a base station and provide wireless communication coverage in a basic service area (BSA) 102. A BSA (e.g., the BSA 102) is the coverage area of an AP (e.g., the AP 104). The AP 104 along with the STAs associated with the AP 104 and that use the AP 104 for communication may be referred to as a basic service set (BSS). It should be noted that the wireless communication system 100 may not have a central AP (e.g., AP 104), but rather may function as a peer-to-peer network between the STAs. Accordingly, the functions of the AP 104 described herein may alternatively be performed by one or more of the STAs.

The AP 104 may transmit on one or more channels (e.g., multiple narrowband channels, each channel including a frequency bandwidth) a beacon signal (or simply a “beacon”), via a communication link such as the downlink 108, to other nodes (STAs) of the wireless communication system 100, which may help the other nodes (STAs) to synchronize their timing with the AP 104, or which may provide other information or functionality. Such beacons may be transmitted periodically. In one aspect, the period between successive transmissions may be referred to as a superframe. Transmission of a beacon may be divided into a number of groups or intervals. In one aspect, the beacon may include, but is not limited to, such information as timestamp information to set a common clock, a peer-to-peer network identifier, a device identifier, capability information, a superframe duration, transmission direction information, reception direction information, a neighbor list, and/or an extended neighbor list, some of which are described in additional detail below. Thus, a beacon may include information that is both common (e.g., shared) amongst several devices and specific to a given device.

In some aspects, a STA (e.g., STA 114) may be required to associate with the AP 104 in order to send communications to and/or to receive communications from the AP 104. In one aspect, information for associating with the AP 104 is included in a beacon broadcast by the AP 104. To receive such a beacon, the STA 114 may, for example, perform a broad coverage search over a coverage region. A search may also be performed by the STA 114 by sweeping a coverage region in a lighthouse fashion, for example. After receiving the information for associating with the AP 104, the STA 114 may transmit a reference signal, such as an association probe or request, to the AP 104. In some aspects, the AP 104 may use backhaul services, for example, to communicate with a larger network, such as the Internet or a public switched telephone network (PSTN).

In an aspect, the STA 114 may include one or more components for performing various functions. For example, the STA 114 may include a packet detection component 124 configured to receive a signal that comprises a first training field and an identifier in a preamble of the signal. The packet detection component 124 may be configured to estimate one or more of a frequency offset of the signal or a timing offset of the signal based at least in part on the first training field and the identifier. The packet detection component 124 may be configured to perform packet detection based at least in part on the first training field and the identifier. In one aspect, the first training field may include a STF and a LTF. In certain other aspects, the STF may include a long range STF and the LTF includes a long range LTF. In certain implementations, the packet detection component 124 may be configured to perform packet detection by storing the STF, the LTF, and the identifier in a buffer. In certain other implementations, the packet detection component 124 may be configured to perform packet detection by determining a first value associated with one or more of the STF or the LTF. In one aspect, the first value may be a signal strength value or a correlation value. In certain other implementations, the packet detection component 124 may be configured to perform packet detection by determining a signal strength of the identifier. In certain other implementations, the packet detection component 124 may be configured to perform packet detection by determining whether a packet is detected based on the first value and the signal strength. In certain other implementations, the packet detection component 124 may be configured to perform packet detection by determining whether the identifier matches a broadcast address or a device identifier associated with a wireless device. In certain other implementations, the packet detection component 124 may perform packet detection in parallel (e.g., concurrently) with timing offset estimation, frequency offset estimation, and channel estimation. In certain aspects, the received signal may also include a second training field in the preamble. In certain other aspects, the packet detection may be based at least in part on the first training field and the second training field of the preamble. The packet detection component 124 may be configured to modify the STF and the LTF stored in the buffer based on one or more of the estimated frequency offset and/or the estimated timing offset. The packet detection component 124 may be configured to perform channel estimation based on one or more of the modified STF, the modified LTF, or the identifier.

In another aspect, the AP 104 may include one or more components for performing various functions. For example, the AP 104 may include a packet detection component 126 configured to receive a signal that comprises a first training field and an identifier in a preamble of the signal. The packet detection component 126 may be configured to estimate one or more of a frequency offset of the signal or a timing offset of the signal based at least in part on the first training field and the identifier. The packet detection component 126 may be configured to perform packet detection based at least in part on the first training field and the identifier. In one aspect, the first training field may include a STF and a LTF. In certain other aspects, the STF may include a long range STF and the LTF includes a long range LTF. In certain implementations, the packet detection component 126 may be configured to perform packet detection by storing the STF, the LTF, and the identifier in a buffer. In certain other implementations, the packet detection component 126 may be configured to perform packet detection by determining a first value associated with one or more of the STF or the LTF. In one aspect, the first value may be a signal strength value or a correlation value. In certain other implementations, the packet detection component 126 may be configured to perform packet detection by determining a signal strength of the identifier. In certain other implementations, the packet detection component 126 may be configured to perform packet detection by determining whether a packet is detected based on the first value and the signal strength. In certain other implementations, the packet detection component 126 may be configured to perform packet detection by determining whether the identifier matches a broadcast address or a device identifier associated with a wireless device. In certain other implementations, the packet detection component 126 may perform packet detection in parallel with timing offset estimation, frequency offset estimation, and channel estimation. In certain aspects, the received signal may also include a second training field in the preamble. In certain other aspects, the packet detection may be based at least in part on the first training field and the second training field in the preamble. The packet detection component 126 may be configured to modify the STF and the LTF stored in the buffer based on one or more of the estimated frequency offset and/or the estimated timing offset. The packet detection component 126 may be configured to perform channel estimation based on one or more of the modified STF, the modified LTF, or the identifier.

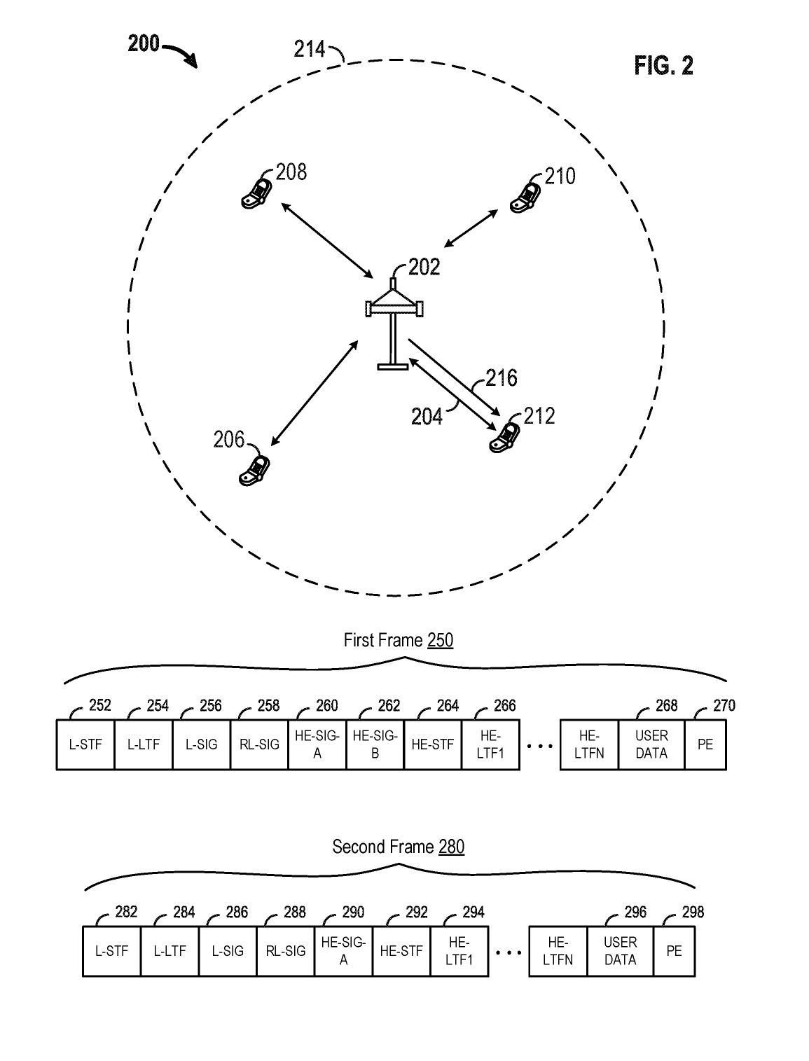

FIG. 2 illustrates a diagram 200 of a wireless network (e.g., a Wi-Fi network employing the IEEE 802.11 standard). The diagram 200 illustrates an AP 202 broadcasting/transmitting within a service area 214. STAs 206, 208, 210, 212 are within the service area 214 of the AP 202 (although four STAs are shown in FIG. 2, more or less STAs may be within the service area 214). The AP 202 may transmit a trigger frame 216 to the STA 212 (and to the STAs 206, 208, 210). The trigger frame 216 may include configuration information related to each of the STAs 206, 208, 210, 212. The STAs 206, 208, 210, 212 may communicate by exchanging frames 204. In some instances, the STA 212, for example, may transmit the frames 204 to the AP 202 in response to the received trigger frame 216. In other instances, the frames 204 may be exchanged between the AP 202 and the STA 206, without a trigger frame.

Referring to FIG. 2, different frame configurations may be used for transmitting information in the wireless network. In a first example, a first frame 250 may be used to transmit data or symbols (e.g., OFDM symbols) such as data symbols or training field symbols, which may include long training field (LTF) symbols and short training field (STF) symbols. The first frame 250 may include a preamble and data. The preamble may be considered a header of the first frame 250 with information identifying a modulation and coding scheme, a transmission rate, and a length of time to transmit the first frame 250, among other information. For example, the preamble may include a legacy preamble that may contain header information for older Wi-Fi standards to enable products incompatible with newer Wi-Fi standards to decode the first frame 250. The legacy preamble may include a legacy short training field (L-STF) 252, a legacy long training field (L-LTF) 254, a legacy signal field (L-SIG) 256, a repetition L-SIG (RL-SIG) 258, and/or other fields. In one configuration, the L-STF 252 may have an 8 μs duration, the L-LTF 254 may have an 8 μs duration, and the L-SIG 256 and RL-SIG may each have an 4 μs duration. Other durations may also be used. Each of the various fields in the legacy preamble may include one or more OFDM symbols. The L-STF 252 may be used for packet detection, to setup automatic gain control (AGC), to acquire coarse frequency offset, and timing synchronization. The L-LTF 284 may include information needed for a receiver (e.g., the STA 206 or the AP 202) to perform channel estimation and for fine frequency offset estimation. The L-SIG 256 and/or the RL-SIG 258 may be used to provide transfer rate and length information.

In addition to the legacy preamble, the preamble may include a high efficiency (HE) preamble. The HE preamble may contain header information related to a future Wi-Fi standard (e.g., the IEEE 802.11ax standard). The HE preamble may include an HE signal field (HE-SIG) A 260, an HE-SIG B 262, an HE short training field (HE-STF) 264, and an HE long training field (HE-LTF) 266, with 1 to N symbols, where N is an integer greater than 0, and/or other fields. The HE-STF 264 may be used to improve AGC. The HE-SIG A 260 and the HE-SIG B 262 may be used to provide transfer rate and length information. And the HE-LTF 266 may be used for channel estimation. The number of symbols in the HE-LTF 266 may be equal to or greater than the number of space-time streams from different STAs. For example, if there are 4 STAs, there may be 4 LTF symbols (i.e., HE-LTF1, HE-LTF2, HE-LTF3, HE-LTF4). The first frame 250 may also include a data field 268 that may contain the user data to be communicated between the STA 206, for example, and the AP 202. The data field 268 may include one or more data symbols. The first frame 250 may also include a packet error (PE) field 270, which may include a frame check sequence (FCS) or other error detection or error correction information. In an aspect, the first frame 250 may correspond to an HE multi-user (MU) physical layer convergence procedure (PLCP) protocol data unit (PPDU) (HE-MU-PPDU).

Referring to FIG. 2, a second frame 280, having a different configuration than the first frame 250, may also be used to transmit information in the wireless network. The second frame 280 may include a preamble that includes an L-STF 282, an L-LTF 284, and L-SIG 286, an RL-SIG 288, an HE-SIG A 290, an HE-STF 292, and/or an HE-LTF 294. The second frame 280 may further include a user data field 296 and a PE field 298. Unlike the first frame 250, the second frame 280 may not have an HE-SIG B field.

WLAN communication systems increasingly look to support lower power and longer range communications. One way to increase communication range is to increase the duration of a preamble of a frame, which improves packet detection. By increasing the preamble duration, however, power reduction is not achieved and overhead is increased. For example, transmission of a small amount of information may require a comparatively long preamble. As such, a need exists to increase the communication range without also increasing power used for transmissions.

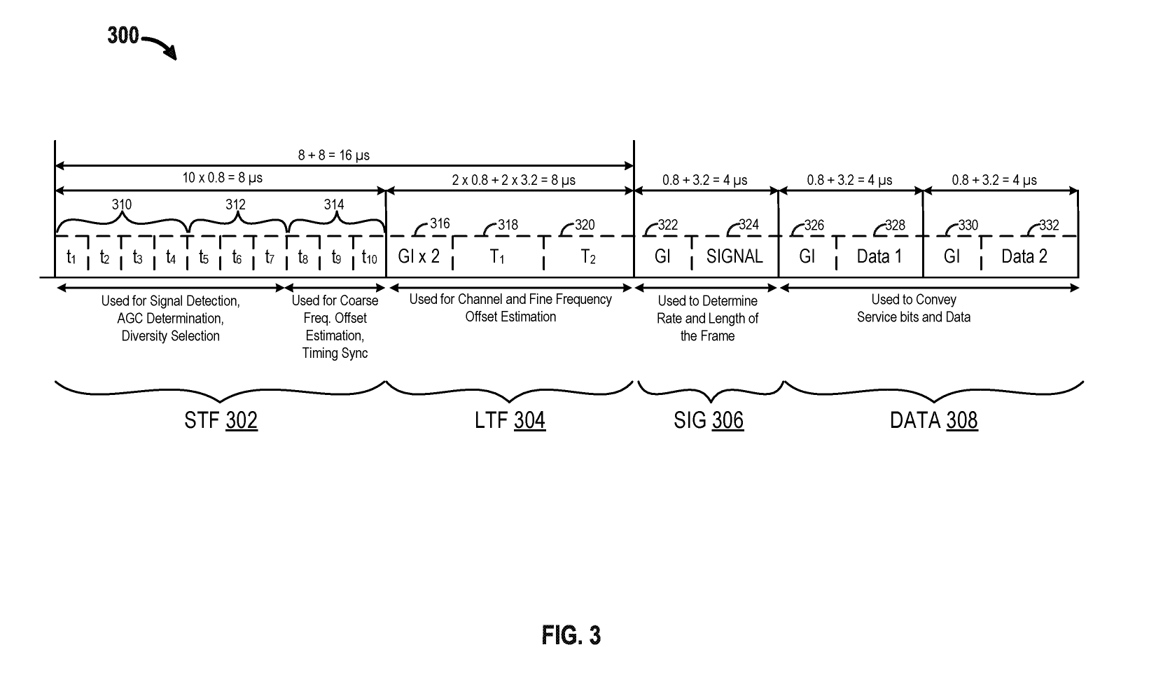

FIG. 3 illustrates an OFDM training structure 300. Referring to FIG. 3, a frame (e.g., the first frame 250 or the second frame 280) may include an STF 302, an LTF 304, a SIG field 306, and a data field 308. The STF 302 may be 8 μs in length and include ten repetitions of a 0.8 μs symbol (e.g., t₁, t₂, . . . t₁₀). The symbols may include a sequence with correlation properties that enables packet detection and timing offset determination. In an aspect, a first subset 310 of the symbols (e.g., t₁, t₂, . . . t₄), may be used for signal or packet detection. A second subset 312 of the symbols (e.g., t₅, t₆, t₇) may be used for AGC setup and diversity selection. A third subset 314 of the symbols (e.g., t₈, t₉, t₁₀) may be used for coarse frequency offset estimation and timing synchronization. The repetitive nature of the STF 302 may be used by correlating a received 0.8 μs symbol with a previously received symbol (e.g., autocorrelation) because the received symbol may be correlated with a delayed version of itself. The autocorrelation technique may be used to determine a timing offset. Further, for initial frequency offset determination, the difference in phase between two samples in the STF, separated by 0.8 μs, allows estimation of the frequency offset. Although the STF 302 is illustrated with a length of 8 μs in FIG. 3, the length of the STF 302 may be longer or shorter than 8 μs without departing from the scope of the present disclosure.

The LTF 304 may be 8 μs in length and include two guard intervals (GI×2) 316, each being 0.8 μs in length. The LTF 304 may also include a first 3.2 μs long training field symbol 318 (e.g., T₁) and a second 3.2 μs long training field symbol 320 (e.g., T₂) used for channel estimation and fine frequency offset estimation. Although the LTF 304 is illustrated with a length of 8 μs in FIG. 3, the length of the LTF 304 may be longer or shorter than 8 μs without departing from the scope of the present disclosure.

Due to symbol repetition, the difference in phase between two samples in the LTF 304 allows a more accurate estimation of the frequency offset. For channel estimation, a Fast Fourier Transform (FFT) may be performed on the symbols in the LTF 304, and the training subcarriers may be extracted. The subcarriers from the first symbol may be averaged with the subcarriers from the second symbol to reduce the effect of noise. Subsequently, using the communication system equation, yₖ=hₖ·Lₖ+zₖ, for each subcarrier k, the known training symbol information (Lₖ) is divided out of the received signal (yₖ) to estimate the channel for each subcarrier k, ĥₖ=yₖ/Lₖ, where noise (zₖ) is ignored.

Following the LTF 304, the SIG field 306 may include a GI 322 along with signal information 324 that may be used to determine the rate and length of the frame. The SIG field 306 may be 4 μs in length. The GI 322 may be 0.8 μs and the signal information 324 may be in a symbol of 3.2 μs in length. Although the SIG field 306 is illustrated with a length of 4 μs in FIG. 3, the length of the SIG field 306 may be longer or shorter than 4 μs without departing from the scope of the present disclosure.

After the SIG field 306, the data field 308 may include a first GI 326 and first data 328 (e.g., Data 1), and a second GI 330 and second data 332 (e.g., Data 2). The data field 308 may be used to convey service bits and data. The length of the data field 308 may be a sum of each of the GI/data symbol groupings 326, 328, 330, 332. Each GI 326, 330 in the data field 308 may be 0.8 μs in length, and each group of data symbols 328, 332 (e.g., Data 1 and Data 2) may be 3.2 μs in length. Although only two GI/data groupings are illustrated in the data field 308 in FIG. 3, more or fewer than two GI/data groupings may be included in the data field 308 without departing from the scope of the present disclosure. In addition, although a GI/data grouping (e.g., GI 326 and data symbols 328) is illustrated with a length of 4 μs, the length of each GI/data grouping in the data field 308 may be longer or shorter than 4 μs without departing from the scope of the present disclosure.

In one aspect, packet detection may be based on the signal-to-noise ratio (SNR) of the STF 302. The STF 302 may be the L-STF (e.g., the L-STF 252, the L-STF 282) or the HE-STF (e.g., the HE-STF 264, or the HE-STF 292). For a packet to be accurately detected, one of the following conditions should be satisfied:

SNR(L-STF)+10 log₁₀(10)>8dB

SNR(HE-STF)+10 log₁₀(10)>8 dB

Referring to the above conditions, SNR(L-STF) may refer to the SNR of the L-STF, SNR(HE-STF) may refer to the SNR of the HE-STF, and 10 log₁₀(10) may correspond to the 10 symbols in the STF. SNR(L-STF) may be determined based on Eq. 1:

SNR(L-STF)=RSSI_{20 MHz}−ThermalNoise_{20 MHz} Eq. 1:

Referring to Eq. 1, RSSI_{20 MHz} may refer to the combined received signal strength indication (RSSI) of the L-STF symbols with 20 MHz bandwidth, and ThermalNoise_{20 MHz} may refer to thermal noise at 20 MHz. Similarly, the SNR(HE-STF) may be determined based on equation 2 below.

SNR(HE-STF)=RSSI_{RU}−ThermalNoise_{RU} Eq. 2:

Referring to Eq. 2, RSSI_{RU} may refer to the combined received signal strength indication (RSSI) of the HE-STF symbols of a particular resource unit (RU) bandwidth (e.g., 2 MHz, 4 MHz, 8 MHz, 16 MHz, 20 MHz, etc.), and ThermalNoise_{RU} may refer to thermal noise at the bandwidth of the RU. With power spectrum density (PSD) boost, the relationship between the RSSI_{RU} and the RSSI_{20 MHz} may be expressed using Eq. 3 below, where α is a fractional bandwidth (e.g., α=BW_{RU}/20 MHz; in a narrowband 2 MHz transmission, then α=0.1).

RSSI_{RU}=RSSI_{20 MHz}+10 log₁₀(α) Eq. 3:

As the sampling rate is lower for an RU with a bandwidth that is less than 20 MHz, the number of samples are lower, and therefore, the RSSI is also lower. As a corollary, the thermal noise relationship may similarly be expressed using Eq. 4 below.

ThermalNoise_{RU}=ThermalNoise_{20 MHz}+10 log₁₀(α) Eq. 4:

If a receiver's bandwidth is 20 MHz, then the HE-STF (trigger-based) single RU packet detection may be equal to the L-STF. As described with respect to FIG. 3, the preamble of the frame, which may include the STF 302, the LTF 304, and the SIG field 306, may be processed in a serial manner.

Future IEEE standards (e.g., IEEE 802.11ax) may provide for narrowband transmissions, such as 2 MHz transmissions. If a STA operates in 2 MHz mode, then the packet detection may be limited by preamble packet detection. In order to maintain the “time×bandwidth” product constant for packet detection, as the channel bandwidth is reduced, the preamble duration may increase. For example, in 20 MHz operation, the “time×bandwidth” product is “20×8.” For 2 MHz operation, to maintain the product constant, the preamble duration may have to be 80 μs, which is the duration of the STF, an IEEE 802.11ah preamble. As previously described, however, increasing the preamble duration does not reduce power nor reduce overhead.

As further described below, in one aspect, a different preamble may be used that enables the concurrent operations of packet detection, timing estimation, frequency offset estimation, and channel estimation. In another aspect, a receiver architecture may be developed that simultaneously performs packet detection, timing estimation, frequency offset estimation, and channel estimation. In another aspect, stations-specific information may be incorporated into a preamble to further facilitate packet detection.

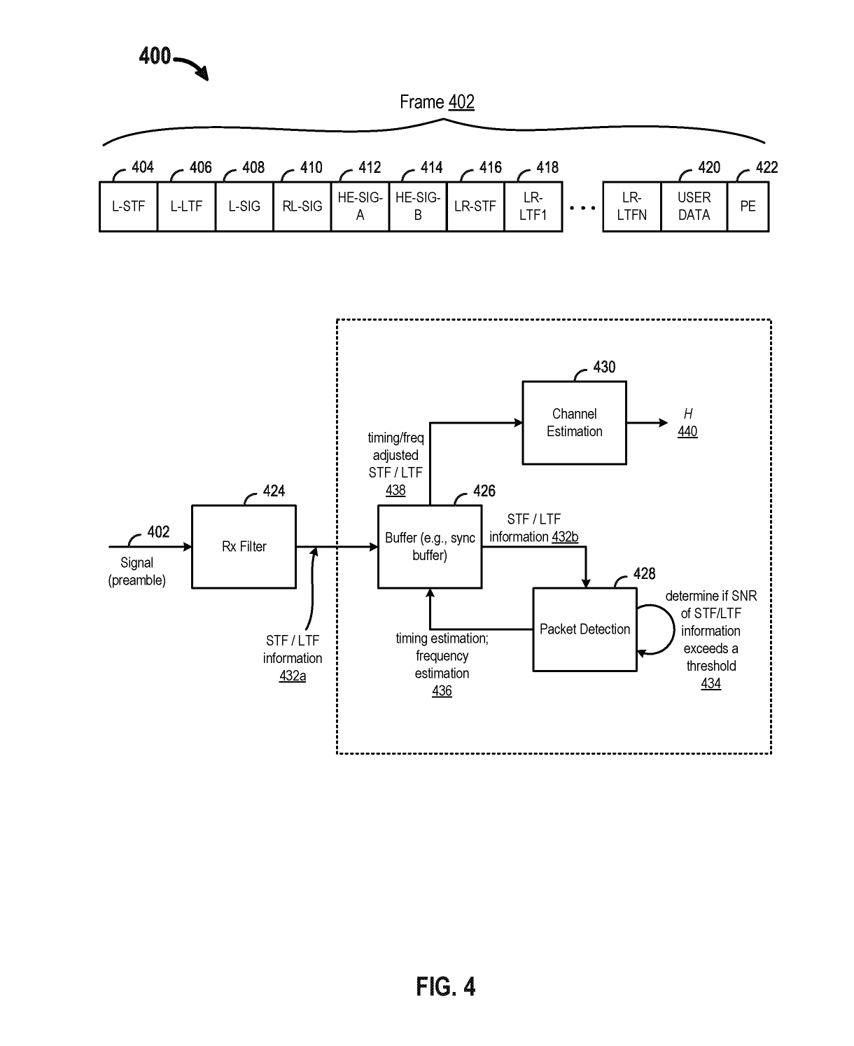

FIG. 4 is a diagram 400 illustrating a first method of packet detection using STF and LTF. Referring to FIG. 4 a wireless device, such as a STA or an AP, may receive a frame 402. In one configuration, the frame 402 may have a preamble that includes an L-STF 404, an L-LTF 406, and L-SIG 408, and RL-SIG 410, an HE-SIG-A 412, an HE-SIG-B 414, a long range (LR) STF (LR-STF) 416, and an LR-LTF 418 (having N symbols, where N is an integer greater than 0). The frame 402 may also include a user data field 420 and a PE field 422. Like the L-STF 404 or the HE-STF (e.g., the HE-STF 264), the LR-STF 416 may have 10 repetitions. However, the LR-STF 416 may have a smaller bandwidth than the L-STF 404 and a bandwidth greater than or equal to the HE-STF (e.g., 2 times greater). Similarly, the LR-LTF 418 may have a smaller bandwidth than the L-LTF 406 and a bandwidth greater than or equal to the HE-LTF (e.g., the HE-LTF 266). In another configuration, the LR-STF 416 may be replaced with an HE-STF, and the LR-LTF 418 may be replaced with an HE-LTF.

Referring to FIG. 4, the wireless device may receive the frame 402 and process the frame 402 to extract STF and LTF information 432a via a receiver filter 424. In one aspect, the STF and LTF information 432a may include at least a portion of the L-STF 404 and the L-LTF 406. In another aspect, the STF and LTF information 432a may include at least a portion of the LR-STF 416 and the LR-LTF 418. In another aspect, the STF and LTF information 432a may include at least a portion of the HE-STF and the HE-LTF. In another aspect, the STF and LTF information 432a may include a combination of the L-STF 404, the L-LTF 406, the LR-STF 416, the LR-LTF 418, the HE-STF, and/or the HE-LTF.

The STF and LTF information 432a may be stored in a buffer 426, such as a circular sync buffer. The STF and LTF information 432b may be provided to a packet detection component 428. The packet detection component 428 may perform packet detection (or preamble matching). In one aspect, the packet detection component 428 may determine whether the STF and LTF information 432b matches any known IEEE 802.11 preamble information based on a correlation value (e.g., using a match filter to perform a correlation or an xcorr (e.g., which returns the cross-correlation of two discrete-time sequences) of a known STF and LTF with the received sample in the buffer). In another aspect, the packet detection component 428 may measure the SNR of the STF and LTF information 432b to determine 434 if the SNR exceeds a packet detection threshold. If the correlation value and/or the SNR is greater than the packet detection threshold, then the packet detection component 428 may determine that a packet is detected. Unlike in other circumstances, the packet detection may be based on both the STF and the LTF information 432b, not just the STF information.

The packet detection component 428 may acquire the frequency offset estimation and the timing offset estimation 436 based on the STF and LTF information. The STF and LTF information 432a in the buffer 426 may be adjusted based on the timing and frequency offset estimation 436 from the packet detection component 428 to output timing/frequency adjusted STF and LTF information 438 to the channel estimation component 430. The STF and LTF information 438 may be reused for channel estimation via the channel estimation component 430 to estimate channel H 440. In an aspect, because both the STF and the LTF are used for packet detection, the gain over STF processing may be

$$10 {log}_{10} ( \frac{{T}_{STF} + {T}_{LTF}}{{T}_{STF}} ) .$$

Given the lower data rate for long range, low power messages, the data processing may be performed at a higher clock speed to finish the processing of the frame 402 and transmit an acknowledgment (ACK) or negative acknowledgment (NACK) after a short interframe space (SIFS). In an aspect, the frame 402 may always include physical layer signal fields and MAC header information. In another aspect, the L-STF 404 and the L-LTF 406 could be used together with the LR-STF 416 and the LR-LTF 418 for packet detection. By using the STF and the LTF (and potentially different types of STF and LTF), the effective length that the receiver uses for the preamble may be increased without increasing the length of the preamble.

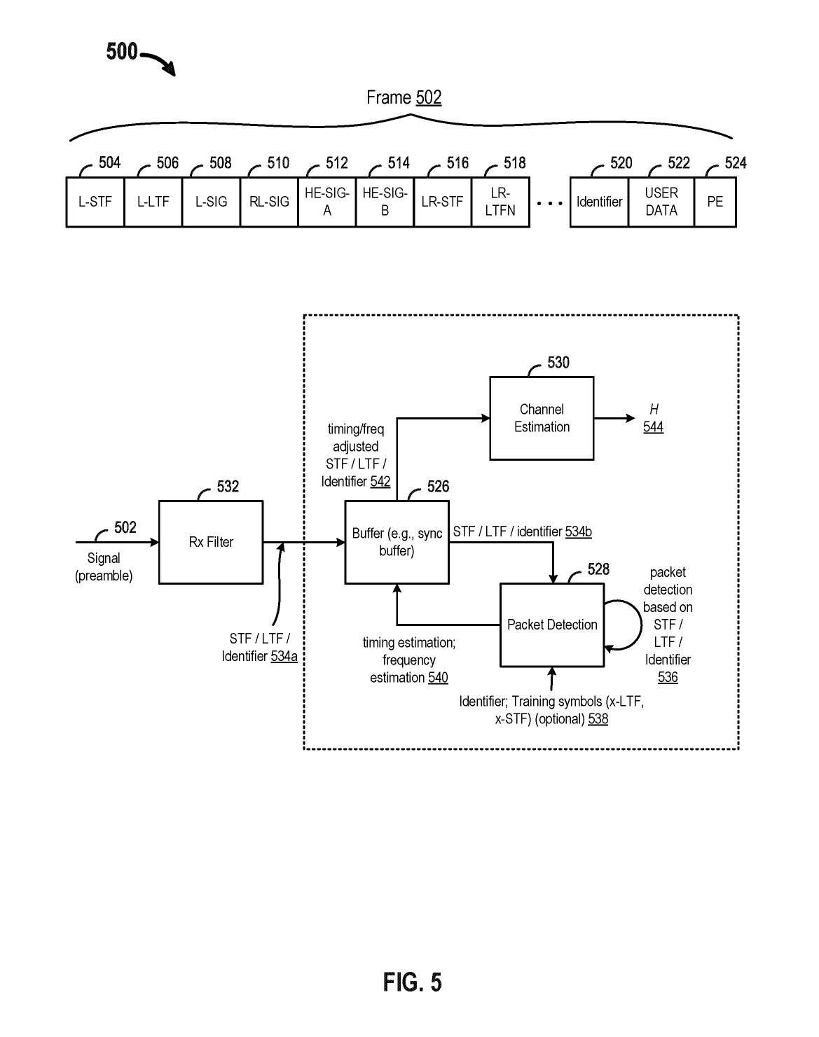

FIG. 5 is a diagram 500 illustrating a second method of packet detection using STF, LTF, and an identifier. Referring to FIG. 5 a wireless device, such as a STA or an AP, may receive a frame 502. In one configuration, the frame 502 may include a preamble, which may include an L-STF 504, an L-LTF 506, an L-SIG 508, an RL-SIG 510, an HE-SIG-A 512, and HE-SIG-B 514, an LR-STF 516, an LR-LTF 518 (having N symbols, where N is an integer greater than 0), and an identifier 520. The frame 502 may also include a user data field 522 and a PE field 524. The identifier 520, located in the preamble, may include an identifier known to the wireless device such as a station identifier or a broadcast address identifier to which the wireless device listens. The identifier may be a MAC address of the wireless device. Like the L-STF 504 or the HE-STF (e.g., the HE-STF 264), the LR-STF 516 may have 10 repetitions. However, the LR-STF 516 may have a smaller bandwidth than the L-STF 504 and a bandwidth greater than or equal to the HE-STF (e.g., 2 times greater). Similarly, the LR-LTF 518 may have a smaller bandwidth than the L-LTF 506 and a bandwidth greater than or equal to the HE-LTF (e.g., the HE-LTF 266). In another configuration, the LR-STF 516 may be replaced with an HE-STF, and the LR-LTF 518 may be replaced with an HE-LTF.

Referring to FIG. 5, the wireless device may receive the frame 502 and process the frame 502 to extract STF, LTF, and identifier information via a receiver filter 532. In one aspect, the STF, LTF, and identifier information 534a may include at least a portion of the L-STF 504 and the L-LTF 506. In another aspect, the STF, LTF, and identifier information 534a may include at least a portion of the LR-STF 516 and the LR-LTF 518. In another aspect, the STF, LTF, and identifier information 534a may include at least a portion of the HE-STF and the HE-LTF. In another aspect, the STF, LTF, and identifier information 534a may include a combination of the L-STF 504, the L-LTF 506, the LR-STF 516, the LR-LTF 518, the HE-STF, and/or the HE-LTF.

The STF, LTF, and identifier information 534a may be stored in a buffer 526, such as a circular sync buffer. The STF, LTF, and identifier information 534b may be provided to a packet detection component 528. The packet detection component 428 may perform packet detection 536 (or preamble matching) based on the STF, LTF, and identifier information 534b. In one aspect, the packet detection component 528 may determine whether the STF and LTF information 534b matches any known IEEE 802.11 preamble information based on a correlation value (e.g., using a match filter xcorr of known STF and LTF values against the received STF and LTF samples in the buffer). In certain aspects, the packet detection component 528 may receive correlation information 538 associated with an identifier and/or training symbols (e.g., x-LTF, x-STF), and use the correlation information 538 to determine whether the SFT and LTF information 534b matches any known IEEE 802.11 preamble information. In another aspect, the packet detection component 528 may measure the SNR of the STF, LTF, and/or identifier information 534b to determine if the SNR exceeds a packet detection threshold. If the correlation value and/or the SNR is greater than the packet detection threshold, then the packet detection component 528 may determine that a packet is detected. The packet detection component 528 may determine if the frame 502 is intended for the wireless device by filtering the preamble for the identifier. If the identifier identifies the wireless device (e.g., a device ID, a station ID, or a MAC address) or is associated with a broadcast address to which the wireless device listens, then the wireless device may continue to process the frame 502 (e.g., determine timing and frequency offsets and perform channel estimation). Otherwise, the wireless device may drop or ignore the frame 502 as if the wireless device never received the frame 502. In an aspect, the identifier 520 may be 16 or 48 bits and coded at the same rate as the preamble (e.g., BPSK ½). Unlike in other circumstances, the packet detection may be based on the STF, LTF, and identifier information, not just the STF information.

The packet detection component 528 may acquire the frequency offset estimation and the timing offset estimation 540 based on the STF, LTF, and/or identifier information. The STF, LTF, and/or identifier information 534a in the buffer 526 may be adjusted based on the timing and frequency offset estimation 540 determined by the packet detection component 528 to obtain timing/frequency adjusted STF, LTF, and/or identifier information 542. The timing/frequency adjusted STF, LTF, and/or identifier information 542 may be sent to the channel estimation component 530. The STF (e.g., the adjusted L-STF 504 and/or the adjusted LR-STF 516), LTF (e.g., the adjusted L-LTF 506 and/or the adjusted LR-LTF 518), and/or identifier information 542 may be reused for channel estimation via the channel estimation component 530 to estimate channel H 544. In an aspect, because the STF, LTF, and/or identifier may be used for packet detection, the gain over STF processing may be

$$10 {log}_{10} ( \frac{{T}_{STF} + {T}_{LTF} + {T}_{identifier}}{{T}_{STF}} ) .$$

Given the lower data rate for long range, low power messages, the data processing may be performed at a higher clock speed to finish the processing of the frame 502 and transmit an acknowledgment after a SIFS. In an aspect, the frame 502 may always include physical layer signal fields and MAC header information. In another aspect, the L-STF 504 and the L-LTF 506 may be used together with the LR-STF 516 and the LR-LTF 518 for packet detection. The identifier 520 may also be used for packet detection. By using the STF, LTF, and identifier (and potentially different types of STF and LTF fields), the effective length that the receiver uses for the preamble may be increased without increasing the actual length of the preamble.

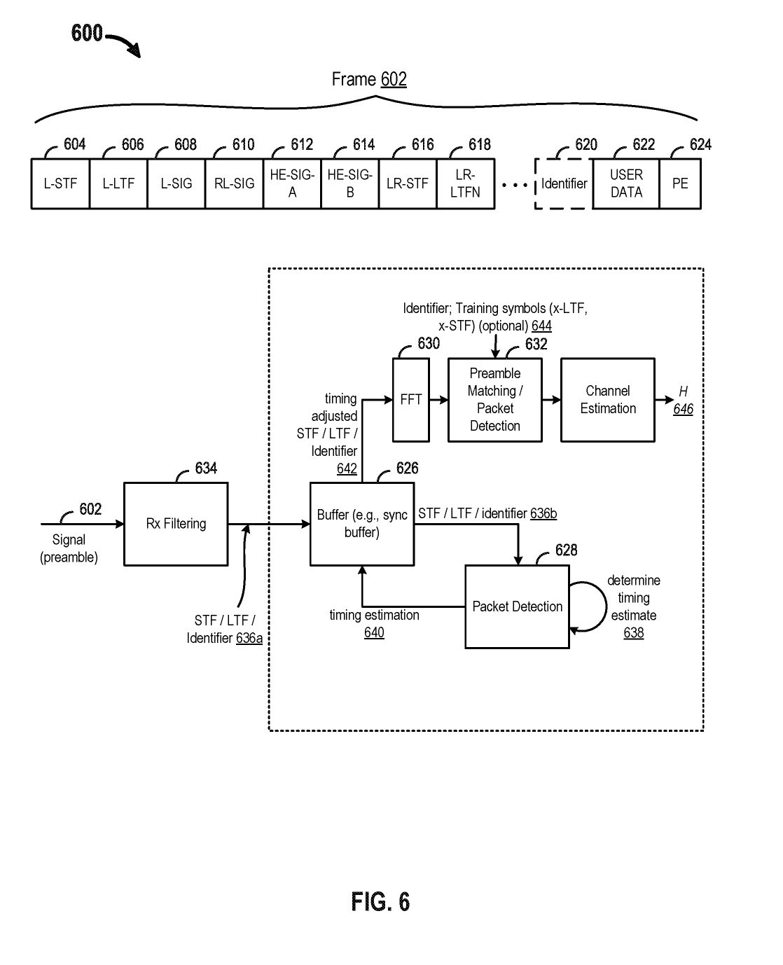

FIG. 6 is a diagram 600 illustrating a third method of packet detection in the frequency domain. Referring to FIG. 6 a wireless device, such as a STA or an AP, may receive a frame 602. In one configuration, the frame 602 may include a preamble, which may include an L-STF 604, an L-LTF 606, an L-SIG 608, an RL-SIG 610, an HE-SIG-A 612, an HE-SIG-B 614, an LR-STF 616, an LR-LTF 618 (having N symbols, where N is an integer greater than 0), and optionally an identifier 620. The frame 602 may also include a user data field 622 and a PE field 624. The identifier 620, located in the preamble, may include an identifier known to the wireless device such as a station identifier or a broadcast address identifier to which the wireless device listens. The identifier may be a MAC address of the wireless device. Like the L-STF 604 or the HE-STF, the LR-STF 616 may have 10 repetitions. However, the LR-STF 616 may have a smaller bandwidth than the L-STF 604 and a bandwidth greater than or equal to the HE-STF (e.g., 2 times greater). Similarly, the LR-LTF 618 may have a smaller bandwidth than the L-LTF 606 and a bandwidth greater than or equal to the HE-LTF. In another configuration, the LR-STF 616 may be replaced with an HE-STF, and the LR-LTF 618 may be replaced with an HE-LTF.

Referring to FIG. 6, the wireless device may receive the frame 602. In an aspect, the wireless device may oversample the frame 602 at 4× or 16×. The wireless device may process the frame 602 to extract STF, LTF, and/or identifier information 636a via a receiver filter 634. In one aspect, the STF, LTF, and/or identifier information 636a may include at least a portion of the L-STF 604 and the L-LTF 606. In another aspect, the STF, LTF, and/or identifier information 636a may include at least a portion of the LR-STF 616 and the LR-LTF 618. In another aspect, the STF, LTF, and/or identifier information 636a may include at least a portion of the HE-STF and the HE-LTF. In another aspect, the STF, LTF, and/or identifier information 636a may include a combination of the L-STF 604, the L-LTF 606, the LR-STF 616, the LR-LTF 618, the HE-STF, and/or the HE-LTF.

The STF, LTF, and/or identifier information 636a may be stored in a buffer 626, such as a circular sync buffer. The STF, LTF, and/or identifier information 636b may be provided to a packet detection component 628. The packet detection component 628 may perform packet detection (or preamble matching). In one aspect, the packet detection component 628 may determine whether the STF and LTF information 636b matches any known IEEE 802.11 preamble information based on a correlation value (e.g., using a match filter xcorr of known STF and LTF values against the received STF and LTF samples in the buffer). In another aspect, the packet detection component 628 may measure the SNR of the STF, LTF, and/or identifier information 636b to determine if the SNR exceeds a packet detection threshold. If the correlation value and/or the SNR satisfies the corresponding packet detection threshold, then the packet detection component 628 may determine that a packet is detected. The packet detection component 628 may determine if the frame 602 is intended for the wireless device by filtering for the identifier. If the identifier identifies the wireless device (e.g., a device ID, a station ID, or a MAC address) or is associated with a broadcast address to which the wireless device listens, then the wireless device may continue to process the frame 602 (e.g., determine timing and frequency offsets and perform channel estimation). Otherwise, the wireless device may drop or ignore the frame 602 as if the wireless device never received the frame 602. In an aspect, the identifier 620 may be 16 or 48 bits and coded at the same rate as the preamble (e.g., BPSK ½). Unlike in other circumstances, the packet detection may be based on the STF, LTF, and identifier information 636b, not just the STF information.

The packet detection component 628 may determine 638 the timing offset estimation and/or the frequency offset estimation 640 based on the STF, LTF, and/or identifier information 636b. The STF, LTF, and/or identifier information in the buffer 626 may be adjusted based on the timing offset estimation and/or the frequency offset estimation 640 from the packet detection component 628. The timing/frequency adjusted STF, LTF, and/or identifier information 642 may be sent to the FFT component 630. The FFT component 630 may apply an FFT to the timing/frequency adjusted STF, LTF, and/or identifier information 642, and send a signal to the preamble matching/packet detection component 632.

The preamble matching/packet detection component 632 may perform packet detection (or preamble matching). In one aspect, the preamble matching/packet detection component 632 may determine whether the STF and LTF information 636b matches any known IEEE 802.11 preamble information based on a correlation value (e.g., using a match filter xcorr of known STF and LTF values against the received STF and LTF samples in the buffer). In certain aspects, the preamble matching/packet detection component 632 may receive correlation information 644 associated with an identifier and/or training symbols (e.g., x-LTF, x-STF), and use the correlation information 644 to determine whether the SFT and LTF information 534b matches any known IEEE 802.11 preamble information. In another aspect, the packet detection component 632 may measure the SNR of the timing/frequency STF, LTF, and/or identifier information (e.g., after the FFT is applied) to determine if the SNR exceeds a packet detection threshold. If the correlation value and/or the SNR satisfies the corresponding packet detection threshold, then the preamble matching/packet detection component 632 may determine that a packet is detected. The preamble matching/packet detection component 632 may determine if the frame 602 is intended for the wireless device by filtering for the identifier. If the identifier identifies the wireless device (e.g., a device ID, a station ID, or a MAC address) or is associated with a broadcast address to which the wireless device listens, then the wireless device may continue to process the frame 602 (e.g., determine timing and frequency offsets and perform channel estimation). Otherwise, the wireless device may drop or ignore the frame 602 as if the wireless device never received the frame 602. In an aspect, the identifier 620 may be 16 or 48 bits and coded at the same rate as the preamble (e.g., BPSK ½). Unlike in other circumstances, the packet detection may be based on the timing/frequency adjusted STF, LTF, and identifier information (e.g., after the FFT is applied), not just the STF information.

The STF (e.g., the adjusted L-STF 604 and/or the adjusted LR-STF 616), LTF (e.g., the adjusted L-LTF 606 and/or the adjusted LR-LTF 618), and/or identifier information 642 may be reused for channel estimation via the channel estimation component 633 after the STF, LTF, and/or identifier information have been transformed via an FFT component 630 to determine estimated channel H 646. In an aspect, because the STF, LTF, and/or identifier are used for packet detection, the gain over STF processing may be

$$10 {log}_{10} ( \frac{{T}_{STF} + {T}_{LTF} + {T}_{identifier}}{{T}_{STF}} ) .$$

Given the lower data rate for long range, low power messages, the data processing may be performed at a higher clock speed to finish the processing of the frame 602 and transmit an acknowledgment after a SIFS. In an aspect, the frame 602 may always include physical layer signal fields and MAC header information. In another aspect, the L-STF 604 and the L-LTF 606 could be used together with the LR-STF 616 and the LR-LTF 618 for packet detection. The identifier 620 may also be used for packet detection. By using the STF, LTF, and identifier (and potentially different types of STF and LTF fields), the effective length that the receiver uses for the preamble may be increased without increasing the actual length of the preamble.

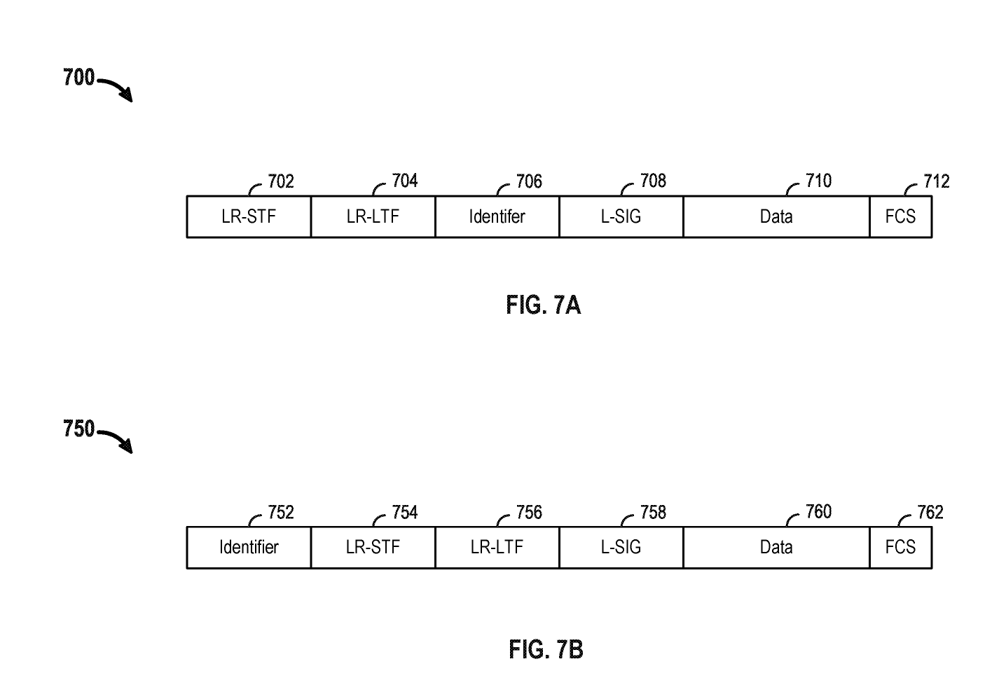

FIGS. 7A and 7B illustrate a first frame structure 700 and a second frame structure 750 with shortened effective preamble durations. Referring to FIG. 7A, the first frame structure 700 may have a preamble that includes LR-STF 702, an LR-LTF 704, an identifier 706 (e.g., the identifier 520), and L-SIG 708. The first frame structure 700 may also include a data field 710 and a FCS 712. The LR-STF 702 may be the LR-STF 416. The LR-LTF 704 may be the LR-LTF 418. Referring to FIG. 7B, the second frame structure 750 may have a preamble that includes an identifier 752 (e.g., the identifier 520), an LR-STF 754, an LR-LTF 756, and an L-SIG 758. The second frame structure 750 may also include a data field 760 and a FCS 762. The LR-STF 754 may be the LR-STF 416. The LR-LTF 756 may be the LR-LTF 418. For the first frame structure 700 and/or the second frame structure 750, packet detection, timing offset, frequency correction, and channel equalization (or channel estimation) may use the LR-STF 702, 754, the LR-LTF 704, 756, and/or the identifier 706, 752. Processing frames having the first frame structure 700 or the second frame structure 750 may be performed in parallel and may reuse the LR-STF 702, 754 and the LR-LTF 704, 756.

In sum, increasing the effective length a receiver uses for the preamble may enable a low power, long range preamble. For example, if at 20 MHz half of the L-STF (4 μs) is used for packet detection, then at 2 MHz, the equivalent time required for packet detection would be 40 μs to keep the same packet detection range. Similarly, if at 20 MHz, the L-LTF duration is 8 μs and is used for channel estimation and fine frequency offset, then the equivalent duration at 2 MHz for channel estimation and fine frequency offset would be 80 μs to maintain the same “time×bandwidth” product constant. However, by utilizing a combination of L-STF, the L-LTF, and/or the identifier along with the LR-STF and the LR-LTF for packet acquisition (e.g., as opposed to using only the L-STF or the L-LTF for packet detection), the effective length of the preamble that the receiver uses for packet detection may be increased. Similarly, HE-STF and/or HE-LTF may also be used instead of the LR-STF and LR-LTF for packet detection. Further, because low power, long range preambles, such as shown in FIGS. 7A and 7B, may not require a high modulation and coding scheme (e.g., may not require MCS 9), the equalizer training duration may be reduced.

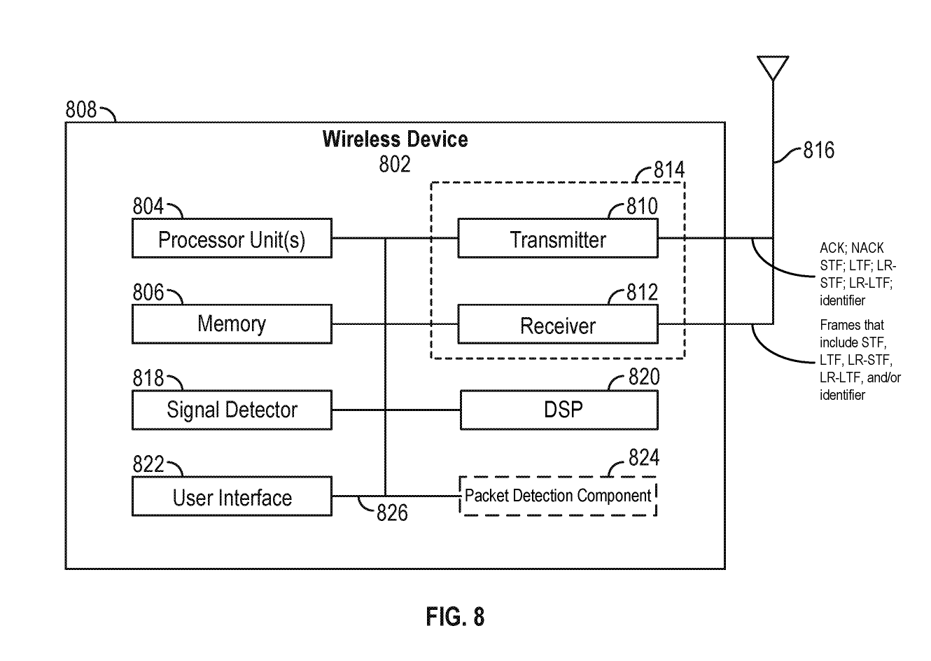

FIG. 8 is a functional block diagram of a wireless communication device 802 that may be employed within the wireless communication system 100 of FIG. 1 for performing packet detection. The wireless communication device 802 is an example of a device that may be configured to implement the various methods described herein. For example, the wireless communication device 802 may be the STAs 112, 114, 116, 118.

The wireless communication device 802 may include a processor 804 which controls operation of the wireless communication device 802. The processor 804 may also be referred to as a central processing unit (CPU). Memory 806, which may include both read-only memory (ROM) and random access memory (RAM), may provide instructions and data to the processor 804. A portion of the memory 806 may also include non-volatile random access memory (NVRAM). The processor 804 may perform logical and arithmetic operations based on program instructions stored within the memory 806. The instructions in the memory 806 may be executable (by the processor 804, for example) to implement the methods described herein.

The processor 804 may comprise or be a component of a processing system implemented with one or more processors. The one or more processors may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information.

The processing system may also include machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing system to perform the various functions described herein.

The wireless communication device 802 may also include a housing 808, and the wireless communication device 802 may include a transmitter 810 and/or a receiver 812 to allow transmission and reception of data between the wireless communication device 802 and a remote device. The transmitter 810 and the receiver 812 may be combined into a transceiver 814. An antenna 816 may be attached to the housing 808 and electrically coupled to the transceiver 814. The wireless communication device 802 may also include multiple transmitters, multiple receivers, multiple transceivers, and/or multiple antennas.

The wireless communication device 802 may also include a signal detector 818 that may be used to detect and quantify the level of signals received by the transceiver 814 or the receiver 812. The signal detector 818 may detect such signals as total energy, energy per subcarrier per symbol, power spectral density, and other signals. The wireless communication device 802 may also include a digital signal processor (DSP) 820 for use in processing signals. The DSP 820 may be configured to generate a packet for transmission. In some aspects, the packet may comprise a physical layer convergence procedure (PLCP) protocol data unit (PPDU).

The wireless communication device 802 may further comprise a user interface 822 in some aspects. The user interface 822 may comprise a keypad, a microphone, a speaker, and/or a display. The user interface 822 may include any element or component that conveys information to a user of the wireless communication device 802 and/or receives input from the user.

The wireless communication device 802 may be an AP or a STA, and the wireless communication device 802 may include a packet detection component 824. The packet detection component 824 may be configured to receive a signal that comprises a first training field and an identifier in a preamble of the signal. The packet detection component 824 may be configured to estimate one or more of a frequency offset of the signal or a timing offset of the signal based at least in part on the first training field and the identifier. The packet detection component 824 may be configured to perform packet detection based at least in part on the first training field and the identifier. In one aspect, the first training field may include a STF and a LTF. In certain other aspects, the STF may include a long range STF and the LTF includes a long range LTF. In certain implementations, the packet detection component 824 may be configured to perform packet detection by storing the STF, the LTF, and the identifier in a buffer. In certain other implementations, the packet detection component 824 may be configured to perform packet detection by determining a first value associated with one or more of the STF or the LTF. In one aspect, the first value may be a signal strength value or a correlation value. In certain other implementations, the packet detection component 824 may be configured to perform packet detection by determining a signal strength of the identifier. In certain other implementations, the packet detection component 824 may be configured to perform packet detection by determining whether a packet is detected based on the first value and the signal strength. In certain other implementations, the packet detection component 824 may be configured to perform packet detection by determining whether the identifier matches a broadcast address or a device identifier associated with a wireless device. In certain other implementations, the packet detection component 824 may perform packet detection in parallel with timing offset estimation, frequency offset estimation, and channel estimation. In certain aspects, the received signal may also include a second training field in the preamble. In certain other aspects, the packet detection may be based at least in part on the first training field and the second training field in the preamble. The packet detection component 824 may be configured to modify the STF and the LTF stored in the buffer based on one or more of the estimated frequency offset and/or the estimated timing offset. The packet detection component 824 may be configured to perform channel estimation based on one or more of the modified STF, the modified LTF, or the identifier.

The various components of the wireless communication device 802 may be coupled together by a bus system 826. The bus system 826 may include a data bus, for example, as well as a power bus, a control signal bus, and a status signal bus in addition to the data bus. Components of the wireless communication device 802 may be coupled together or accept or provide inputs to each other using some other mechanism.

Although a number of separate components are illustrated in FIG. 8, one or more of the components may be combined or commonly implemented. For example, the processor 804 may be used to implement the functionality described above with respect to the processor 804, as well as to implement the functionality described above with respect to the signal detector 818, the DSP 820, the user interface 822, and/or the packet detection component 824. Further, each of the components illustrated in FIG. 8 may be implemented using a plurality of separate elements.

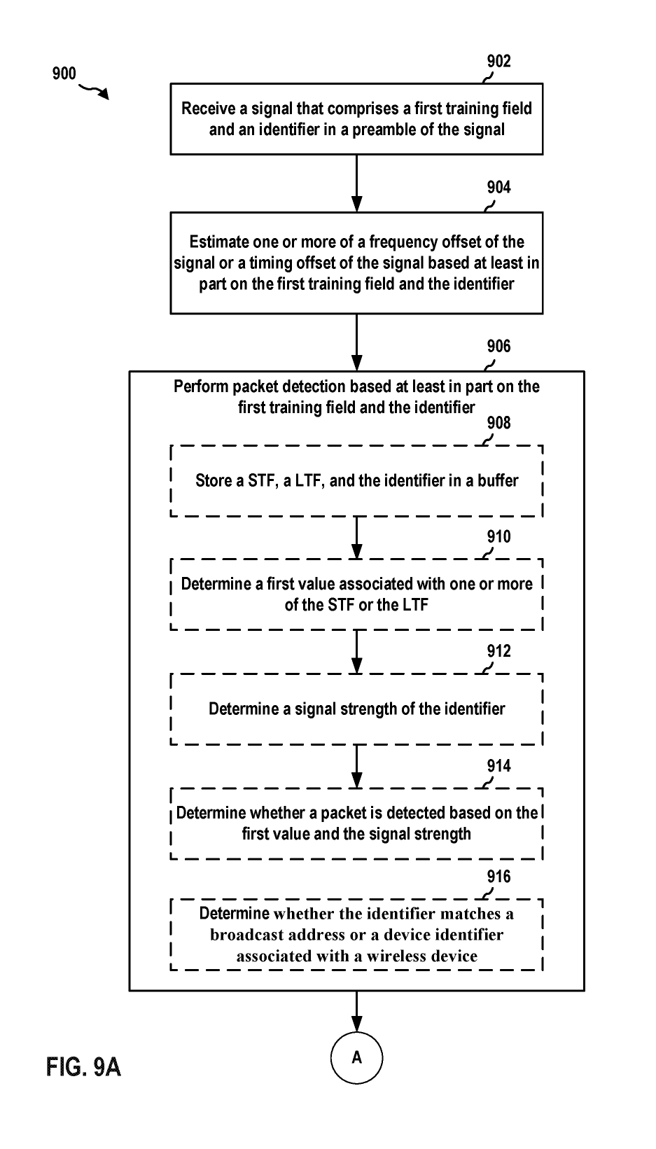

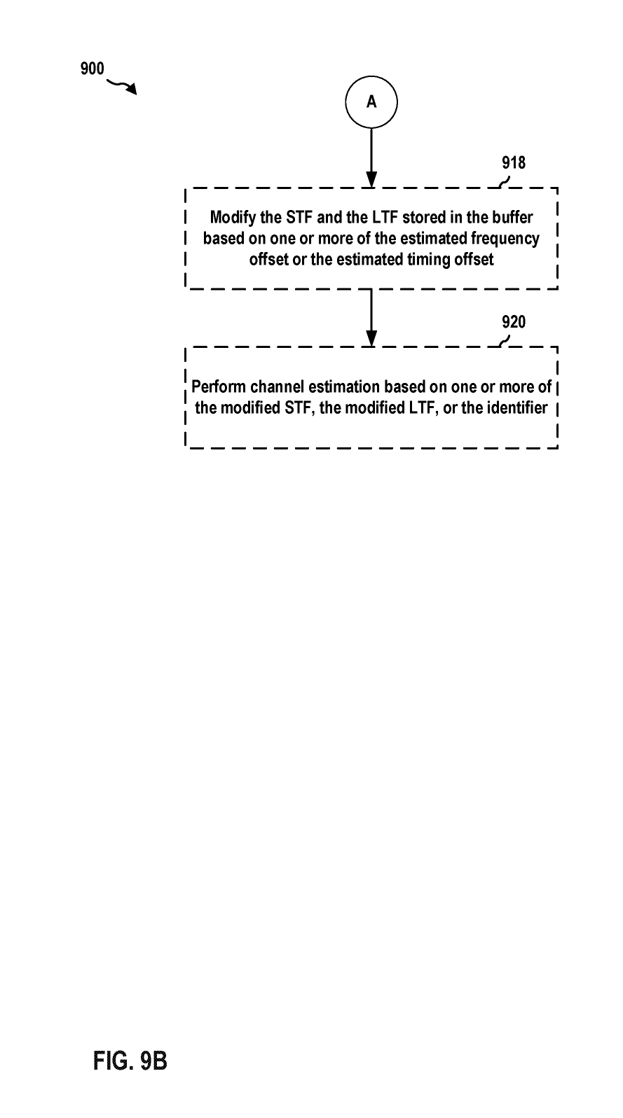

FIGS. 9A and 9B are a flowchart of an exemplary method 900 of wireless communication for packet detection in accordance with certain aspects of the disclosure. The method 900 may be performed using an apparatus (e.g., the AP 104, the STA 114, the wireless communication device 802, 1000). In FIGS. 9A and 9B, operations indicated with dashed lines indicate optional operations.

Referring to FIG. 9A, at 902, the apparatus may receive a signal that comprises a first training field and an identifier in a preamble of the signal. In certain aspects, the first training field may be used to determine the identifier. In certain other aspects, the first training field may include a STF and a LTF. In certain other aspects, the STF includes a long range STF and the LTF includes a long range LTF. For example, referring to FIG. 6, a wireless device, such as a STA or an AP, may receive a frame 602. In one configuration, the frame 602 may include a preamble, which may include an L-STF 604, an L-LTF 606, an L-SIG 608, an RL-SIG 610, an HE-SIG-A 612, an HE-SIG-B 614, an LR-STF 616, an LR-LTF 618 (having N symbols, where N is an integer greater than 0), and optionally an identifier 620.

At 904, the apparatus may estimate one or more of a frequency offset of the signal or a timing offset of the signal based at least in part on the first training field and the identifier. For example, referring to FIG. 6, if the identifier identifies the wireless device (e.g., a device ID, a station ID, or a MAC address) or is associated with a broadcast address to which the wireless device listens, then the wireless device may continue to process the frame 602 (e.g., determine timing and frequency offsets and perform channel estimation).

At 906, the apparatus may perform packet detection based at least in part on the first training field and the identifier. In certain aspects, the received signal may further comprise a second training field in the preamble. In certain other aspects, the packet detection may be based at least in part on the first training field and the second training field in the preamble. In certain other aspects, the packet detection may be performed in parallel with timing offset estimation, frequency offset estimation, and channel estimation. For example, referring to FIG. 6, the packet detection component 628 may perform packet detection (or preamble matching). In one aspect, the packet detection component 628 may determine whether the STF and LTF information matches any known IEEE 802.11 preamble information based on a correlation value (e.g., using a match filter xcorr of known STF and LTF values against the received STF and LTF samples in the buffer). In another aspect, the packet detection component 628 may measure the SNR of the STF, LTF, and/or identifier information to determine if the SNR exceeds a packet detection threshold. If the correlation value and/or the SNR is greater than the packet detection threshold, then the packet detection component 628 may determine that a packet is detected. The packet detection component 628 may determine if the frame 602 is intended for the wireless device by filtering for the identifier. If the identifier identifies the wireless device (e.g., a device ID, a station ID, or a MAC address) or is associated with a broadcast address to which the wireless device listens, then the wireless device may continue to process the frame 602 (e.g., determine timing and frequency offsets and perform channel estimation).

At 908, the apparatus may perform packet detection by storing the STF, the LTF, and the identifier in a buffer. For example, referring to FIG. 6, the STF, LTF, and/or identifier information may be stored in a buffer 626, such as a circular sync buffer. The STF, LTF, and/or identifier information may be provided to a packet detection component 628.

At 910, the apparatus may perform packet detection by determining a first value associated with one or more of the STF or the LTF. For example, referring to FIG. 6, the packet detection component 628 may measure the SNR of the STF, LTF, and/or identifier information to determine if the SNR exceeds a packet detection threshold. If the correlation value and/or the SNR is greater than the packet detection threshold, then the packet detection component 628 may determine that a packet is detected.

At 912, the apparatus may perform packet detection by determining a signal strength of the identifier. For example, referring to FIG. 6, the packet detection component 628 may measure the SNR of the STF, LTF, and/or identifier information to determine if the SNR exceeds a packet detection threshold. If the correlation value and/or the SNR is greater than the packet detection threshold, then the packet detection component 628 may determine that a packet is detected.

At 914, the apparatus may perform packet detection by determining whether a packet is detected based on the first value and the signal strength. In certain aspects, the first value may include a signal strength value or a correlation value. For example, referring to FIG. 6, the packet detection component 628 may measure the SNR of the STF, LTF, and/or identifier information to determine if the SNR exceeds a packet detection threshold. If the correlation value and/or the SNR is greater than the packet detection threshold, then the packet detection component 628 may determine that a packet is detected.

At 916, the apparatus may perform packet detection by determining whether the identifier matches a broadcast address or a device identifier associated with a wireless device. For example, referring to FIG. 6, if the identifier identifies the wireless device (e.g., a device ID, a station ID, or a MAC address) or is associated with a broadcast address to which the wireless device listens, then the wireless device may continue to process the frame 602 (e.g., determine timing and frequency offsets and perform channel estimation).

Referring to FIG. 9B, at 918, the apparatus may modify the STF and the LTF stored in the buffer based on one or more of the estimated frequency offset or the estimated timing offset. For example, referring to FIG. 6, the STF, LTF, and/or identifier information in the buffer 626 may be adjusted based on the timing offset estimation and/or the frequency offset estimation from the packet detection component 628. The STF (e.g., the adjusted L-STF 604 and/or the adjusted LR-STF 616), LTF (e.g., the adjusted L-LTF 606 and/or the adjusted LR-LTF 618), and/or identifier information may be reused for channel estimation via the channel estimation component 633 after the STF, LTF, and/or identifier information have been transformed via an FFT component 630.

At 920, the apparatus may perform channel estimation based on one or more of the modified STF, the modified LTF, or the identifier. For example, referring to FIG. 6, the STF, LTF, and/or identifier information in the buffer 626 may be adjusted based on the timing offset estimation and/or the frequency offset estimation from the packet detection component 628. The STF (e.g., the adjusted L-STF 604 and/or the adjusted LR-STF 616), LTF (e.g., the adjusted L-LTF 606 and/or the adjusted LR-LTF 618), and/or identifier information may be reused for channel estimation via the channel estimation component 633 after the STF, LTF, and/or identifier information have been transformed via an FFT component 630.

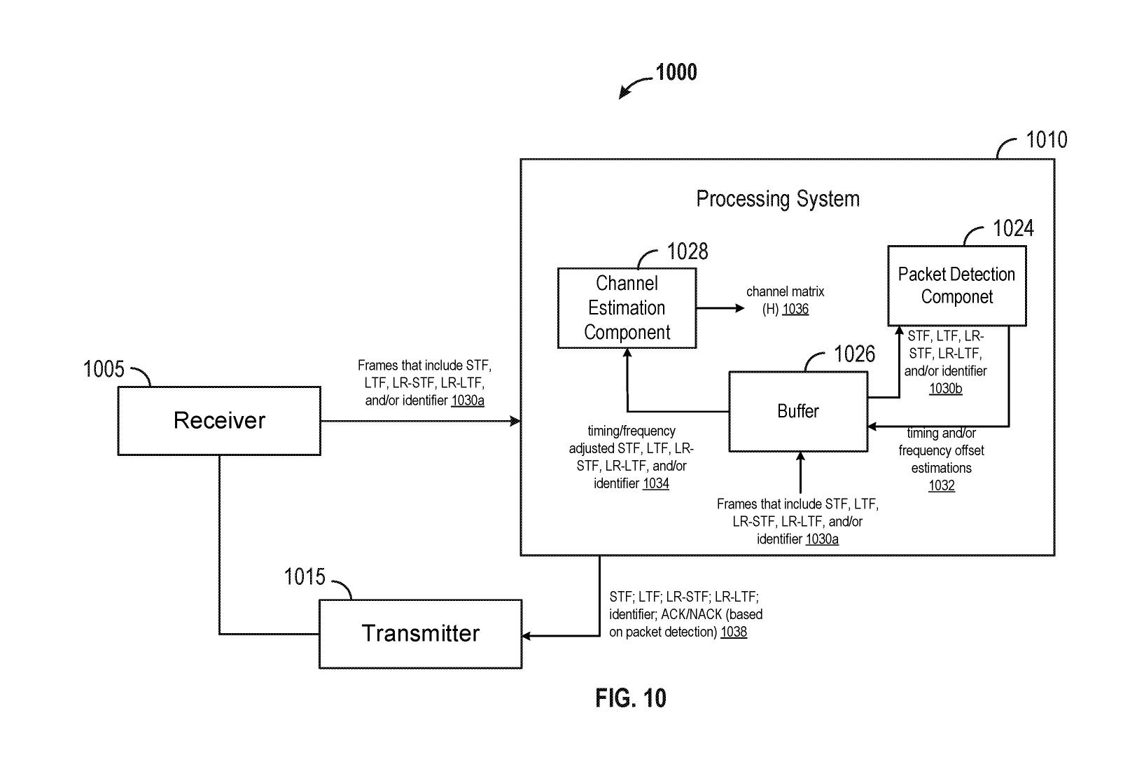

FIG. 10 is a functional block diagram of an exemplary wireless communication device 1000 for performing packet detection. The wireless communication device 1000 may include a receiver 1005 that may be configured to receive frames 1030a that include STF, LTF, LR-STF, LR-LTF, and/or an identifier, a processing system 1010, and a transmitter 1015 that may be configured to receive STF, LTF, LR-STF, LR-LTF, identifier, and/or ACK/NACK information 1038 based on packet detection. The processing system 1010 may include a buffer 1026 that is configured to receive frames 1030a that include STF, LTF, LR-STF, LR-LTF, and/or an identifier from the receiver 1005 and configured to send information 1030b associated with STF, LTF, LR-STF, LR-LTF, and/or an identifier to a packet detection component 1024, the packet detection component 1024 may be configured to receive information 1030b associated with STF, LTF, LR-STF, LR-LTF, and/or an identifier from the buffer 1026 and send information 1032 associated with timing and/or frequency offset estimations to the buffer 1026, and/or a channel estimation component 1028 that is configured to receive information 1034 associated with timing/frequency adjusted STF, LTF, LR-STF, LR-LTF, and/or an identifier from the buffer 1026 and configured to output an estimated channel matrix (H) 1036. The receiver 1005, the processing system 1010, the transmitter 1015, the buffer 1026, the channel estimation component 1028, and/or the packet detection component 1024 may be configured to perform one or more of the aforementioned functions.

For example, the receiver 1005, the processing system 1010, and/or the packet detection component 1024 may be configured to receive a signal that comprises a first training field and an identifier in a preamble of the signal. The processing system 1010, the channel estimation component 1028, and/or the packet detection component 1024 may be configured to estimate one or more of a frequency offset of the signal or a timing offset of the signal based at least in part on the first training field and the identifier. The processing system 1010 and/or the packet detection component 1024 may be configured to perform packet detection based at least in part on the first training field and the identifier. In one aspect, the first training field may include a STF and a LTF. In certain other aspects, the STF may include a long range STF and the LTF includes a long range LTF. In certain implementations, the processing system 1010, the buffer 1026, and/or the packet detection component 1024 may be configured to perform packet detection by storing the STF, the LTF, and the identifier in a buffer. In certain other implementations, the processing system 1010, the buffer 1026, and/or the packet detection component 1024 may be configured to perform packet detection by determining a first value associated with one or more of the STF or the LTF. In one aspect, the first value may be a signal strength value or a correlation value. In certain other implementations, the processing system 1010 and/or the packet detection component 1024 may be configured to perform packet detection by determining a signal strength of the identifier. In certain other implementations, the processing system 1010, the buffer 1026, and/or the packet detection component 1024 may be configured to perform packet detection by determining whether a packet is detected based on the first value and the signal strength. In certain other implementations, the processing system 1010 and/or the packet detection component 1024 may be configured to perform packet detection by determining whether the identifier matches a broadcast address or a device identifier associated with a wireless device. In certain other implementations, the processing system 1010, the channel estimation component 1028, and/or the packet detection component 1024 may perform packet detection in parallel with timing offset estimation, frequency offset estimation, and channel estimation. In certain aspects, the received signal may also include a second training field in the preamble. In certain other aspects, the packet detection may be based at least in part on the first training field and the second training field in the preamble. The processing system 1010, the buffer 1026, the channel estimation component 1028, and/or the packet detection component 1024 may be configured to modify the STF and the LTF stored in the buffer based on one or more of the estimated frequency offset and/or the estimated timing offset. The processing system 1010, the buffer 1026, the channel estimation component 1028, and/or the packet detection component 1024 may be configured to perform channel estimation based on one or more of the modified STF, the modified LTF, or the identifier.

The receiver 1005, the processing system 1010, the packet detection component 1024, the buffer 1026, the channel estimation component 1028, and/or the transmitter 1015 may be configured to perform one or more functions discussed above with respect to 902, 904, 906, 908, 910, 912, 914, 916, 918, 920 of FIGS. 9A and 9B. The receiver 1005 may correspond to the receiver 812. The processing system 1010 may correspond to the processor 804. The transmitter 1015 may correspond to the transmitter 810. The packet detection component 1024 may correspond to the packet detection component 124, the packet detection component 126, and/or the packet detection component 824.

In certain implementations, the wireless communication device 1000 may include means for receiving (e.g., the receiver 1005, the processing system 1010, and/or the packet detection component 1024) a signal that comprises a first training field and an identifier in a preamble of the signal. The wireless communication device 1000 may include means for estimating (e.g., the processing system 1010, the channel estimation component 1028, and/or the packet detection component 1024) one or more of a frequency offset of the signal or a timing offset of the signal based at least in part on the first training field and the identifier. The wireless communication device 1000 may include means for performing (e.g., the processing system 1010, the buffer 1026, and/or the packet detection component 1024) packet detection based at least in part on the first training field and the identifier. In one aspect, the first training field may include a STF and a LTF. In certain other aspects, the STF may include a long range STF and the LTF includes a long range LTF. In certain implementations, the means for performing (e.g., the processing system 1010, the buffer 1026, and/or the packet detection component 1024) packet detection may be configured to store the STF, the LTF, and the identifier in a buffer. In certain other implementations, the means for performing (e.g., the processing system 1010, the buffer 1026, and/or the packet detection component 1024) packet detection may be configured to determine a first value associated with one or more of the STF or the LTF. In one aspect, the first value may be a signal strength value or a correlation value. In certain other implementations, the means for performing (e.g., the processing system 1010, the buffer 1026, and/or the packet detection component 1024) packet detection may be configured to determine a signal strength of the identifier. In certain other implementations, the means for performing (e.g., the processing system 1010, the buffer 1026, and/or the packet detection component 1024) packet detection may be configured to determine whether a packet is detected based on the first value and the signal strength. In certain other implementations, the means for performing (e.g., the processing system 1010, the buffer 1026, and/or the packet detection component 1024) packet detection may be configured to determine whether the identifier matches a broadcast address or a device identifier associated with a wireless device. In certain other implementations, the means for performing (e.g., the processing system 1010, the buffer 1026, and/or the packet detection component 1024) packet detection may be configured to perform packet detection in parallel with timing offset estimation, frequency offset estimation, and channel estimation. In certain aspects, the received signal may also include a second training field in the preamble. In certain other aspects, the packet detection may be based at least in part on the first training field and the second training field in the preamble. In certain other implementations, the wireless communication device 1000 may include means for modifying (e.g., the processing system 1010, the buffer 1026, the channel estimation component 1028, and/or the packet detection component 1024) the STF and the LTF stored in the buffer based on one or more of the estimated frequency offset and/or the estimated timing offset. In certain other implementations, the wireless communication device 1000 may include means for performing (e.g., the processing system 1010, the buffer 1026, the channel estimation component 1028, and/or the packet detection component 1024) may be configured to perform channel estimation based on one or more of the modified STF, the modified LTF, or the identifier.

The various operations of methods described above may be performed by any suitable means capable of performing the operations, such as various hardware and/or software component(s), circuits, and/or module(s). Generally, any operations illustrated in the Figures may be performed by corresponding functional means capable of performing the operations.

The various illustrative logical blocks, components and circuits described in connection with the present disclosure may be implemented or performed with a general purpose processor, a DSP, an application specific integrated circuit (ASIC), an FPGA or other PLD, discrete gate or transistor logic, discrete hardware components or any combination thereof designed to perform the functions described herein. A general purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

In one or more aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, compact disk (CD)-ROM (CD-ROM) or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes CD, laser disc, optical disc, digital versatile disc (DVD), floppy disk and Blu-ray disc where disks usually reproduce data magnetically, while discs reproduce data optically with lasers. Thus, computer readable medium comprises a non-transitory computer readable medium (e.g., tangible media).

The methods disclosed herein may include one or more blocks or actions for achieving the described method. The method blocks and/or actions may be interchanged with one another without departing from the scope of the claims. In other words, unless a specific order of blocks or actions is specified, the order and/or use of specific blocks and/or actions may be modified without departing from the scope of the claims.

Thus, certain aspects may comprise a computer program product for performing the operations presented herein. For example, such a computer program product may comprise a computer readable medium having instructions stored (and/or encoded) thereon, the instructions being executable by one or more processors to perform the operations described herein. For certain aspects, the computer program product may include packaging material.

Further, it should be appreciated that components and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a CD or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

While the foregoing is directed to aspects of the present disclosure, other and further aspects of the disclosure may be devised without departing from the basic scope thereof, and the scope thereof is determined by the claims that follow.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112(f), unless the element is expressly recited using the phrase “means for” or, in the case of a method claim, the element is recited using the phrase “step for.”

What is claimed is:

1. A method of wireless communication, comprising:
receiving a signal that comprises a first training field and an identifier associated with a wireless device in a preamble of the signal;
estimating one or more of a frequency offset of the signal or a timing offset of the signal based at least in part on the first training field and the identifier associated with the wireless device; and
performing packet detection based at least in part on the first training field and the identifier associated with the wireless device.

2. The method of claim 1, wherein the first training field includes a short training field (STF) and a long training field (LTF), the performing packet detection comprising:
determining a first value associated with one or more of the STF or the LTF;
determining a signal strength of the identifier associated with the wireless device; and
determining whether a packet is detected based on the first value and the signal strength of the identifier associated with the wireless device.

3. The method of claim 2, wherein the first value is a signal strength value associated with one or more of the STF or the LTF, or the first value is a correlation value of known STF values or known LTF values.

4. The method of claim 2, further comprising:
modifying at least one of a timing or a frequency associated with the STF and the LTF based on one or more of the estimated frequency offset or the estimated timing offset; and
performing channel estimation based on one or more of the modified STF, the modified LTF, or the identifier associated with the wireless device.

5. The method of claim 2, wherein:
the STF includes a legacy STF (L-STF) and a long range STF (LR-STF),
the LTF includes a legacy LTF (L-LTF) and a long range LTF (LR-LTF),
the LR-STF is associated with a first bandwidth that is smaller than a second bandwidth associated with the L-STF, and
the LR-LTF is associated with a third bandwidth that is smaller than a fourth bandwidth associated with the L-LTF.

6. The method of claim 1, wherein the packet detection is performed concurrently with timing offset estimation, frequency offset estimation, and channel estimation.

7. The method of claim 1, wherein:
the received signal further comprises a second training field in the preamble, and
the packet detection is based at least in part on the first training field and the second training field in the preamble.

8. The method of claim 1, wherein the performing packet detection comprises:
determining whether the identifier matches a broadcast address or a device identifier associated with a wireless device.

9. An apparatus for wireless communication, comprising:
a memory; and
at least one processor coupled to the memory and configured to:
receive a signal that comprises a first training field and an identifier associated with a wireless device in a preamble of the signal;
estimate one or more of a frequency offset of the signal or a timing offset of the signal based at least in part on the first training field and the identifier associated with the wireless device; and
perform packet detection based at least in part on the first training field and the identifier associated with the wireless device.

10. The apparatus of claim 9, wherein the first training field includes a short training field (STF) and a long training field (LTF), the at least one processor is configured to perform packet detection by:
determining a first value associated with one or more of the STF or the LTF;
determining a signal strength of the identifier associated with the wireless device; and
determining whether a packet is detected based on the first value and the signal strength of the identifier associated with the wireless device.

11. The apparatus of claim 10, wherein the first value is a signal strength value associated with one or more of the STF or the LTF, or the first value is a correlation value of known STF values or known LTF values.

12. The apparatus of claim 10, wherein the at least one processor is further configured to:
modify at least one of a timing or a frequency associated with the STF and the LTF based on one or more of the estimated frequency offset or the estimated timing offset; and
perform channel estimation based on one or more of the modified STF, the modified LTF, or the identifier associated with the wireless device.

13. The apparatus of claim 10, wherein:
the STF includes a legacy STF (L-STF) and a long range STF (LR-STF),
the LTF includes a legacy LTF (L-LTF) and a long range LTF (LR-LTF),
the LR-STF is associated with a first bandwidth that is smaller than a second bandwidth associated with the L-STF, and
the LR-LTF is associated with a third bandwidth that is smaller than a fourth bandwidth associated with the L-LTF.

14. The apparatus of claim 9, wherein the packet detection is performed concurrently with timing offset estimation, frequency offset estimation, and channel estimation.

15. The apparatus of claim 9, wherein:
the received signal further comprises a second training field in the preamble, and
the packet detection is based at least in part on the first training field and the second training field in the preamble.

16. The apparatus of claim 9, wherein the at least one processor is configured to perform packet detection by:
determining whether the identifier matches a broadcast address or a device identifier associated with a wireless device.

17. An apparatus for wireless communication, comprising:
means for receiving a signal that comprises a first training field and an identifier associated with a wireless device in a preamble of the signal;
means for estimating one or more of a frequency offset of the signal or a timing offset of the signal based at least in part on the first training field and the identifier associated with the wireless device; and
means for performing packet detection based at least in part on the first training field and the identifier associated with the wireless device.

18. The apparatus of claim 17, wherein the first training field includes a short training field (STF) and a long training field (LTF), the means for performing packet detection is configured to:
determine a first value associated with one or more of the STF or the LTF;
determine a signal strength of the identifier associated with the wireless device; and
determine whether a packet is detected based on the first value and the signal strength of the identifier associated with the wireless device.

19. The apparatus of claim 18, wherein the first value is a signal strength value associated with one or more of the STF or the LTF, or the first value is a correlation value of known STF values or known LTF values.

20. The apparatus of claim 18, further comprising:
means for modifying at least one of a timing or a frequency associated with the STF and the LTF based on one or more of the estimated frequency offset or the estimated timing offset; and
means for performing channel estimation based on one or more of the modified STF, the modified LTF, or the identifier associated with the wireless device.

21. The apparatus of claim 18, wherein:
the STF includes a legacy STF (L-STF) and a long range STF (LR-STF),
the LTF includes a legacy LTF (L-LTF) and a long range LTF (LR-LTF),
the LR-STF is associated with a first bandwidth that is smaller than a second bandwidth associated with the L-STF, and
the LR-LTF is associated with a third bandwidth that is smaller than a fourth bandwidth associated with the L-LTF.

22. The apparatus of claim 17, wherein the packet detection is performed concurrently with timing offset estimation, frequency offset estimation, and channel estimation.

23. The apparatus of claim 17, wherein:
the received signal further comprises a second training field in the preamble, and
the packet detection is based at least in part on the first training field and the second training field in the preamble.

24. The apparatus of claim 17, wherein the means for performing packet detection is configured to:
determine whether the identifier matches a broadcast address or a device identifier associated with a wireless device.

25. A computer-readable medium storing computer executable code, comprising code to:
receive a signal that comprises a first training field and an identifier associated with a wireless device in a preamble of the signal;
estimating one or more of a frequency offset of the signal or a timing offset of the signal based at least in part on the first training field and the identifier associated with the wireless device; and
performing packet detection based at least in part on the first training field and the identifier associated with the wireless device.

26. The computer-readable medium of claim 25, wherein the first training field includes a short training field (STF) and a long training field (LTF), and wherein the code to perform packet detection is configured to:
determine a first value associated with one or more of the STF or the LTF;
determine a signal strength of the identifier associated with the wireless device; and
determine whether a packet is detected based on the first value and the signal strength of the identifier associated with the wireless device.

27. The computer-readable medium of claim 26, wherein the first value is a signal strength value associated with one or more of the STF or the LTF, or the first value is a correlation value of known STF values or known LTF values.

28. The computer-readable medium of claim 26, further comprising code to:
modify at least one of a timing or a frequency associated with the STF and the LTF based on one or more of the estimated frequency offset or the estimated timing offset; and
perform channel estimation based on one or more of the modified STF, the modified LTF, or the identifier associated with the wireless device.

29. The computer-readable medium of claim 26, wherein:
the STF includes a legacy STF (L-STF) and a long range STF (LR-STF),
the LTF includes a legacy LTF (L-LTF) and a long range LTF (LR-LTF),
the LR-STF is associated with a first bandwidth that is smaller than a second bandwidth associated with the L-STF, and
the LR-LTF is associated with a third bandwidth that is smaller than a fourth bandwidth associated with the L-LTF.

30. The computer-readable medium of claim 25, wherein the packet detection is performed concurrently with timing offset estimation, frequency offset estimation, and channel estimation.
